(19) United States
(12) Patent Application Publication
(10) Pub. No.: US 2007/0060221 A1
(43) Pub. Date: Mar. 15, 2007

(54) Speaker voice coil antenna

(75) Inventors: John M. Burgan, North Palm Beach, FL (US); Joseph Patino, Pembroke Pines, FL (US); Russell L. Simpson, Miami, FL (US); Jason T. Young, Palm City, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/224,251

(22) Filed: Sep. 12, 2005

(51) Int. Cl. H04B 1/06; H04M 1/00

(52) U.S. Cl. 455/575.7; 455/274

(57) ABSTRACT

A wireless communication device (50) can include a radio frequency transceiver (52), an audio drive circuit (58) coupled to the transceiver, a speaker (10) having a voice coil (16) coupled to the audio drive circuit, and an antenna feed or radiating circuit (20) such as an RFID or NFID circuit coupled to the voice coil for at least radiating or receiving an electromagnetic signal via the voice coil. Such radiating circuits can be coupled to the voice coil using a band pass circuit designed to substantially prevent a radiating signal from the radiating circuit from interfering with audio drive circuit driving the speaker. The wireless communication device can further include an antenna (54) coupled to the radio frequency transceiver. Note, this arrangement can be designed to avoid problems involving electrostatic discharge sensitivity, electromagnetic interference coupling between the antenna and the voice coil, total radiated power, and specific absorption rate.

### FIELD OF THE INVENTION

This invention relates generally to antennas, and more particularly to an antenna using a speaker component.

### BACKGROUND OF THE INVENTION

Circuits to implement Near Field Identification (NFID) and Radio Frequency Identification (RFID) technology are rapidly dropping in cost to the point where such technology will likely be included in cell phones. Unfortunately, the current antenna designs for cell phones are not suitable for the requirements of NFID/RFID technology. The unsuitable nature of current cell phone antennas for NFID/RFID technology necessitates the inclusion of additional antennas into the cell phone, creating a host of engineering problems related to Electrostatic discharge (ESD) sensitivity, Electromagnetic Interference (EMI), coupling between the multiple antennas in the phone affecting the main antenna's performance and Total Radiated Power (TRP), as well as issues with Specific Absorption Rates (SAR).

### SUMMARY OF THE INVENTION

Embodiments in accordance with the present invention utilize a speaker element to effectively operate as an antenna. In one embodiment, the use of a voice coil from a speaker provides a solution for radiating and/or receiving NFID or RFID signals utilizing components that typically exist in current cell phones and other wireless device.

In a first embodiment of the present invention, an antenna can include a speaker having a voice coil and an antenna feed coupled to the voice coil for at least radiating or receiving an electromagnetic signal. The antenna can further include a radiating circuit such as an RFID or NFID circuit coupled to the voice coil. Such radiating circuits can be coupled to the voice coil using a band pass circuit designed to substantially prevent a radiating signal from the radiating circuit from interfering with audio circuitry driving the speaker. The speaker can also be constructed from non-metallic support frames and grills. The voice coil can be designed to have a resonance at a predetermined frequency selected to avoid interference with the operation of the speaker.

In a second embodiment of the present invention, a wireless communication device can include a radio frequency transceiver, an audio drive circuit coupled to the transceiver, a speaker having a voice coil coupled to the audio drive circuit, and an antenna feed coupled to the voice coil for at least radiating or receiving an electromagnetic signal via the voice coil. The voice coil can serve as an antenna and wireless communication device can further include a radiating circuit such as an RFID or NFID circuit coupled to the voice coil. Such radiating circuits can be coupled to the voice coil using a band pass circuit designed to substantially prevent a radiating signal from the radiating circuit from interfering with audio drive circuit driving the speaker. The wireless communication device can further include an antenna coupled to the radio frequency transceiver. Note, the antenna coupled to the radio frequency transceiver and the voice coil used as a radiating element are arranged to avoid problems involving electrostatic discharge sensitivity, electromagnetic interference coupling between the antenna and the voice coil, total radiated power, and specific absorption rate.

In a third embodiment of the present invention, a cellular phone having near field identification or radio frequency identification capability, can include a radio frequency transceiver for cellular communications, an antenna coupled to the radio frequency transceiver, an audio drive circuit coupled to the transceiver, and a speaker having a voice coil coupled to the audio drive circuit where the voice coil radiates or receives electromagnetic signals for near field identification or radio frequency identification signaling. The voice coil serves as an antenna for radio frequency identification transmissions or near field identification transmissions. The cellular phone can further include a radiating circuit coupled to the voice coil using a band pass circuit designed to substantially prevent a radiating signal from the radiating circuit from interfering with the audio drive circuit driving the speaker. The antenna coupled to the radio frequency transceiver and the voice coil used as a radiating element can be arranged to avoid problems involving electrostatic discharge (ESD) sensitivity, electromagnetic interference (EMI) coupling between the antenna and the voice coil, total radiated power (TRP), and specific absorption rate (SAR).

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a speaker voice coil used as a radiating element in accordance with an embodiment of the present invention.

FIG. 2 is a block diagram of a wireless communication device using a speaker voice coil as a radiating element in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

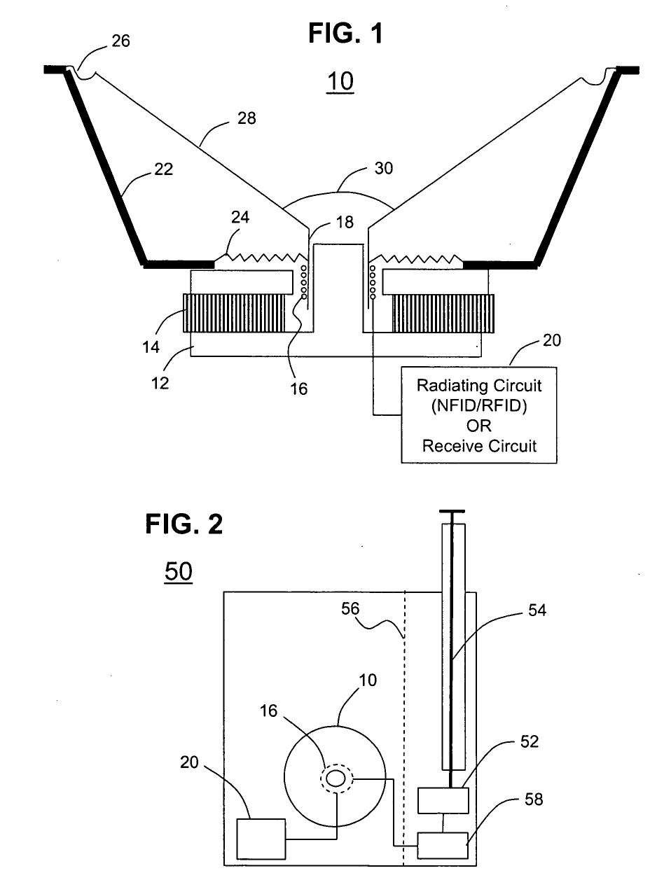

The basic construction of a speaker or loudspeaker 10 and voice coil 16 serving as an antenna or antenna element in accordance with an embodiment of the present invention is illustrated in FIG. 1. The speaker 10 can include a magnet assembly 12 for retaining a magnet 14 and a basket assembly or frame 22. The frame 22 can be substantially enclosed with a surround 26 coupled to a top portion of the frame 22, a cone or diaphragm 28 coupled to the surround 26 and a former 18. A dust cap 30 can cover the center area of the cone or diaphragm 28. The frame 22 can be coupled to the former via a spider 24. The voice coil or coils 16 can be wound around the former 18 as illustrated. The description of the construction of the speaker above is well known and the embodiment herein are not necessarily limited to such construction. The voice coil 16 in the embodiment above or in other arrangements will serve as an antenna element such as a radiating element or radio frequency (RF) transducer. Inasmuch as the voice coil 16 services as an antenna, an antenna feed or radiating circuit 20 can be coupled to the voice coil 16. Note, the radiating circuit 20 can also be a receive circuit and in one particular embodiment can be an NFID or RFID circuit.

Referring to FIG. 2, a wireless communication device 50 is shown including the speaker 10 with the voice coils 16 and the radiating circuit 20. The wireless communication device 50 can further include a radio frequency transceiver circuit 52 commonly found in a cellular phone and an antenna 54 coupled to the transceiver circuit 52. Optionally, the wireless communication device 50 can include additionally shielding 56 to further reduce interference and other detrimental effect between or among circuits 20 and 52.

In the case where the radiating circuit is an NFID or RFID circuit, the arrangement of FIG. 2 avoids the addition of another antenna in a practical design for a cell phone for example. Note, when a standard cell phone speaker was excited with a signal in the frequency range commonly used for RFID in an experiment, the radiated signal was easily detected with a spectrum analyzer. The RFID or NFID signal can be coupled to the speaker using band pass circuits (within circuit 20 for example) that prevents the signal from interfering with or being interfered with by the audio circuitry 58 currently driving the speaker 10. Enhanced performance can be achieved by limiting the amount of metal between the speaker voice coil and the outside of the phone, so support frames and grills (see 12 and 22 in FIG. 1) can be made of non-metallic materials such as plastic instead of metal.

In other practical embodiments, the voice coil 16 can be designed to resonate at a specified frequency to reduce any anticipated detrimental affects that can occur during acoustic performance. Basically, can be a tradeoff with the actual speaker operation in designing the radiating aspects of the voice coil 16. Thus, adjustments to speaker designs will need to take into account the specific applications that will be used such as the radiating frequency of the coil and the acoustic performance desire from the speaker. For example, the magnet material loading at the RFID or NFID frequencies can possibly be adjusted. Note, the voice coil 16 in the applications herein do not necessarily require shielded coils. The embodiments herein can simply use a capacitive tap to the speaker coil 16.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An antenna, comprising:
a speaker having a voice coil; and
an antenna feed coupled to the voice coil for at least radiating or receiving an electromagnetic signal.

2. The antenna of claim 1, wherein the antenna further comprises a radio frequency identification circuit coupled to the voice coil.

3. The antenna of claim 1, wherein the antenna further comprises a near field identification circuit coupled to the voice coil.

4. The antenna of claim 1, wherein the antenna further comprises a radiating circuit coupled to the voice coil using a band pass circuit designed to substantially prevent a radiating signal from the radiating circuit from interfering with audio circuitry driving the speaker.

5. The antenna of claim 1, wherein the speaker is constructed having non-metallic support frames and grills.

6. The antenna of claim 1, wherein the voice coil has a resonance at a predetermined frequency selected to avoid interference with the operation of the speaker.

7. A wireless communication device, comprising:
a radio frequency transceiver;
an audio drive circuit coupled to the transceiver;
a speaker having a voice coil coupled to the audio drive circuit; and
an antenna feed coupled to the voice coil for at least radiating or receiving an electromagnetic signal via the voice coil.

8. The wireless communication device of claim 7, wherein the voice coil serves as an antenna for radio frequency identification transmissions.

9. The wireless communication device of claim 7, wherein the voice coil serves as an antenna for near field identification transmissions.

10. The wireless communication device of claim 7, wherein the wireless communication device further comprises an antenna coupled to the radio frequency transceiver.

11. The wireless communication device of claim 8, wherein the wireless communication device further comprises a radio frequency identification circuit coupled to the voice coil.

12. The wireless communication device of claim 8, wherein the wireless communication device further comprises a near field identification circuit coupled to the voice coil.

13. The wireless communication device of claim 8, wherein the wireless communication device further comprises a radiating circuit coupled to the voice coil using a band pass circuit designed to substantially prevent a radiating signal from the radiating circuit from interfering with the audio drive circuit driving the speaker.

14. The wireless communication device of claim 8, wherein the speaker is constructed having non-metallic support frames and grills.

15. The wireless communication device of claim 8, wherein the voice coil has a resonance at a predetermined frequency selected to avoid interference with the operation of the speaker.

16. The wireless communication device of claim 10, wherein the antenna coupled to the radio frequency transceiver and the voice coil used as a radiating element are arranged to avoid problems involving electrostatic discharge sensitivity, electromagnetic interference coupling between the antenna and the voice coil, total radiated power, and specific absorption rate.

17. A cellular phone having near field identification or radio frequency identification capability, comprising:
a radio frequency transceiver for cellular communications;
an antenna coupled to the radio frequency transceiver;
an audio drive circuit coupled to the transceiver;
a speaker having a voice coil coupled to the audio drive circuit, wherein the voice coil radiates or receives electromagnetic signals for near field identification or radio frequency identification signaling.

18. The cellular phone of claim 17, wherein the voice coil serves as an antenna for radio frequency identification transmissions or near field identification transmissions.

19. The cellular phone of claim 17, wherein the cellular phone further comprises a radiating circuit coupled to the voice coil using a band pass circuit designed to substantially prevent a radiating signal from the radiating circuit from interfering with the audio drive circuit driving the speaker.

20. The cellular phone of claim 17, wherein the antenna coupled to the radio frequency transceiver and the voice coil used as a radiating element are arranged to avoid problems involving electrostatic discharge sensitivity, electromagnetic interference coupling between the antenna and the voice coil, total radiated power, and specific absorption rate.
